(19) United States
(12) Patent Application Publication
(10) Pub. No.: US 2025/0322461 A1
(43) Pub. Date: Oct. 16, 2025

(54) ARTIFICIAL INTELLIGENCE AIDED INVESTMENT ANALYSIS SYSTEM FOR BIOTECHNOLOGY REGULATORY APPROVALS

(71) Applicants: Giorgio Casaburi, San Marcos, CA (US); Antonio Simeone, Rome (IT); Claudio Bruni, Milan (IT); Paolo Mariotti, Forli (IT); Eugenio Pasquariello, Campobasso (IT); Emanuele Ricco, Salerno (IT)

(72) Inventors: Giorgio Casaburi, San Marcos, CA (US); Antonio Simeone, Rome (IT); Claudio Bruni, Milan (IT); Paolo Mariotti, Forli (IT); Eugenio Pasquariello, Campobasso (IT); Emanuele Ricco, Salerno (IT)

(21) Appl. No.: 19/175,755

(22) Filed: Apr. 10, 2025

Related U.S. Application Data
(60) Provisional application No. 63/634,059, filed on Apr. 15, 2024.

(51) Int. Cl. G06Q 40/06

(52) U.S. Cl. CPC G06Q 40/06

(57) ABSTRACT

An artificial intelligence-aided investment analysis system is disclosed for predicting the market impact of regulatory approvals in the biotechnology sector. The system addresses the challenge of accurately assessing market signals by integrating qualitative and quantitative analyses. The system utilizes a combination of qualitative AI models and quantitative AI models to process diverse data inputs, including textual information and financial metrics. The integration module aggregates insights to generate buy/sell signals enhancing investment decision-making. The system employs advanced techniques such as large language models, neural networks, and ensemble learning to provide timely and reliable predictions. This innovative approach offers a comprehensive solution for investors navigating the complexities of biotechnology investments, enabling informed decisions based on a nuanced understanding of scientific developments and market trends.

### CROSS-REFERENCE TO RELATED APPLICATIONS

This application claims benefit to Provisional Application No. 63/634,059, filed Apr. 15, 2024, the contents of which are herein incorporated by reference.

### BACKGROUND OF THE INVENTION

### Field of Endeavor

The present invention relates to financial technology, and more particularly, to a system for predicting market impact of regulatory approvals for biotechnology company products.

### Background of Related Art

The biotechnology industry offers substantial investment opportunities but is characterized by complexities and uncertainties due to the rigorous regulatory frameworks governing product approvals. Investors and analysts often face challenges in accurately assessing the potential market impact of these approvals, as evaluating biotechnology products typically requires specialized knowledge not readily accessible to those outside the medical field.

Existing systems for predicting market impact primarily rely on historical financial data and broad qualitative assessments, which may overlook important scientific advancements and fail to adapt to rapidly changing market dynamics. These systems often necessitate significant manual intervention, making real-time predictions difficult and potentially unreliable. There is a need for a more sophisticated approach that effectively integrates both qualitative and quantitative analyses to provide accurate and timely predictions of market signals for biotechnology companies.

Current methods may misinterpret the significance of research milestones or fail to account for the nuanced interplay between scientific developments and market trends. As a result, investors are left with incomplete or inaccurate information, hindering their ability to make informed decisions.

An innovative solution is required to address these shortcomings, offering a streamlined and comprehensive system that leverages advanced models to enhance the precision and reliability of investment analyses in the biotechnology sector.

### SUMMARY OF THE INVENTION

In one embodiment, the disclosure provides an Artificial Intelligence (AI) system for predicting market impact of regulatory approvals for a company. The system comprises at least one processor and at least one memory and includes a Qualitative AI module configured to ingest qualitative inputs and process these inputs using large language models along with an attention mechanism to generate qualitative insights regarding the company. Also included is a Quantitative AI module configured to ingest quantitative inputs and analyze these inputs using a plurality of neural networks to generate quantitative insights regarding the company. An integration module operatively coupled to both the Qualitative and Quantitative AI modules aggregates, weighs, and synthesizes the qualitative insights and quantitative analyses into a comprehensive market prediction signal, and a decision module outputs actionable investment signals to guide buy, sell, or exit decisions.

In another embodiment, the plurality of neural networks comprises an Adaptive Neuro Fuzzy Inference Neural Network that includes a first layer for transforming the quantitative inputs into transformed inputs, a second layer for fuzzifying these transformed inputs to form fuzzy inputs, a third layer for applying fuzzy rules to determine relationships and generate fuzzy outputs, a fourth layer for defuzzifying the fuzzy outputs based on predetermined rules to form defuzzified outputs, and a fifth layer for generating signals based on the defuzzified outputs.

In further embodiments, the attention mechanism incorporates a recurrent neural network configured to prioritize certain qualitative inputs over additional inputs. The qualitative inputs may include non-numerical inputs such as textual information derived from research papers, news articles, and publicly available sources, while the qualitative insights may reflect aspects of a company's research quality, innovation indices, company profile, or competitive positioning.

In other embodiments, the quantitative inputs include numerical time-series data, stock prices, trading volumes, or other financial metrics.

### BRIEF DESCRIPTION OF THE DRAWINGS

FIG. 1 is a schematic diagram of a first portion of a Quantitative Artificial Intelligence (AI) System, according to aspects of the present invention;

FIG. 2 is a block diagram an embodiment of an Adaptive Neuro Fuzzy Inference System, accord to aspects of the present invention;

FIG. 3 is a schematic diagram of a second portion of a Quantitative Artificial Intelligence (AI) System, according to aspects of the present invention;

FIG. 4 is a flow diagram of a Ensemble Learning, according to aspects of the present invention;

FIG. 5 is a flow diagram of an embodiment of a Large Language Model (LLM), according to aspects of the present invention;

FIG. 6 is a schematic diagram of a structure of integrated LLMs, according to aspects of the present invention;

FIG. 7 is a flow diagram of an embodiment of a Qualitative AI, according to aspects of the present invention; and

FIG. 8 is a flow diagram of an Overall Predictive System of the present invention, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

The biotechnology industry offers substantial investment opportunities, yet the sector is fraught with complexities and uncertainties due to the stringent regulatory frameworks governing product approvals. Investors and analysts often face challenges in accurately assessing the potential market impact of these approvals. Evaluating biotechnology products generally requires specialized knowledge that is not readily accessible to individuals outside the medical field. This lack of accessibility can lead to misinterpretations and incomplete analyses, hindering informed investment decisions.

Current systems for predicting the market impact of regulatory approvals predominantly rely on historical financial data and broad qualitative assessments. These methods may overlook significant scientific advancements and fail to adapt to rapidly changing market dynamics. Additionally, they often require substantial manual intervention, making real-time predictions difficult and potentially unreliable. Such systems may misinterpret the significance of research milestones or fail to account for the nuanced interplay between scientific developments and market trends, leaving investors with incomplete or inaccurate information.

The present system addresses these shortcomings by providing a sophisticated solution that integrates both qualitative and quantitative analyses to enhance the precision and reliability of investment analyses in the biotechnology sector. This system leverages advanced artificial intelligence models to predict market signals for biotechnology companies, offering a streamlined and comprehensive approach. By combining qualitative insights from scientific evaluations with quantitative data from financial markets, the system provides a more accurate and timely prediction of market impacts, thereby empowering investors to make more informed decisions.

FIG. 8 shows the Predictive AI System 800, which integrates both qualitative AI input 802 and quantitative AI input 806 models to generate market predictions, specifically buy/sell signals 812. The system is designed to leverage diverse data inputs and sophisticated AI models to enhance the accuracy and reliability of investment decisions in the biotechnology sector.

The Qualitative AI Input 802 represents the initial data source for the qualitative AI model 804. This input consists of non-numerical data, such as textual information from research papers, news articles, and other publicly available sources. In embodiments, Qualitative inputs 802 can pass through one or more pre-processing phases prior to being fed into Qualitative AI 804. In embodiments, the one or more pre-processing phases can include data cleaning, outlier removal, and/or normalization. The qualitative AI model 804 processes this input to extract meaningful insights and features that are relevant to the biotechnology market. This model employs techniques such as large language models (LLMs) and attention mechanisms to analyze the qualitative aspects of the data, including the reputation of research teams, innovation indices, and competitive landscapes.

Similarly, the Quantitative AI Input 806 serves as the data source for the quantitative AI model 808. This input includes numerical data such as stock prices, trading volumes, and other financial metrics. The quantitative AI model 808 processes this data using advanced mathematical functions, technical indicators, and machine learning algorithms to identify patterns and trends in the market. This model is capable of handling time-series data and employs techniques such as neural networks and ensemble learning to generate predictions based on quantitative analysis.

The Integration Module 810 plays an important role in the Predictive AI System 800. This module aggregates the outputs from both the qualitative AI model 804 and the quantitative AI model 808. The integration process involves weighing the insights from both AI streams based on their relevance and reliability. The Integration Module 810 processes two distinct data processing pipelines: one dedicated to the qualitative analysis of scientific and biomedical information, and the other to the quantitative evaluation of market behavior. On the one hand, qualitative pipeline leverages large language models (LLMs) trained on domain-specific corpora, including clinical trial repositories, biomedical literature databases such as PubMed, patent filings, and institutional research reports. On the other hand the quantitative AI pipeline ingests a continuous stream of historical and real-time financial data related to over 500 publicly traded U.S. biotech companies. The Integration Module 810 can be an AI-driven decision fusion model, which assimilates both qualitative and quantitative outputs into a singular decision metric. This model, often implemented using ensemble machine learning algorithms receives a multidimensional input vector representing features such as the molecule's scientific score, the associated trial phase, quantitative indicators like relative strength index (RSI), historical return momentum, trading volume anomalies, and time-to-event windows and through a deep neural network classifies the investment opportunity into a categorical output—typically Buy, Hold, or Sell—with an accompanying confidence score. The module utilizes statistical models and machine learning techniques to combine the qualitative and quantitative data, producing a comprehensive analysis that informs the final market prediction.

The Buy/Sell Signal 812 is the result of the integration process. This signal represents the actionable investment decision generated by the Predictive AI System 800. The recommendation is based on the combined insights from the qualitative AI input 802 and the quantitative AI input 806 analyses, offering investors a robust and reliable suggestion for market entry or exit. The system's capacity to integrate diverse data sources and sophisticated AI models ensures that the buy/sell signals are well-informed and adaptive to changing market conditions.

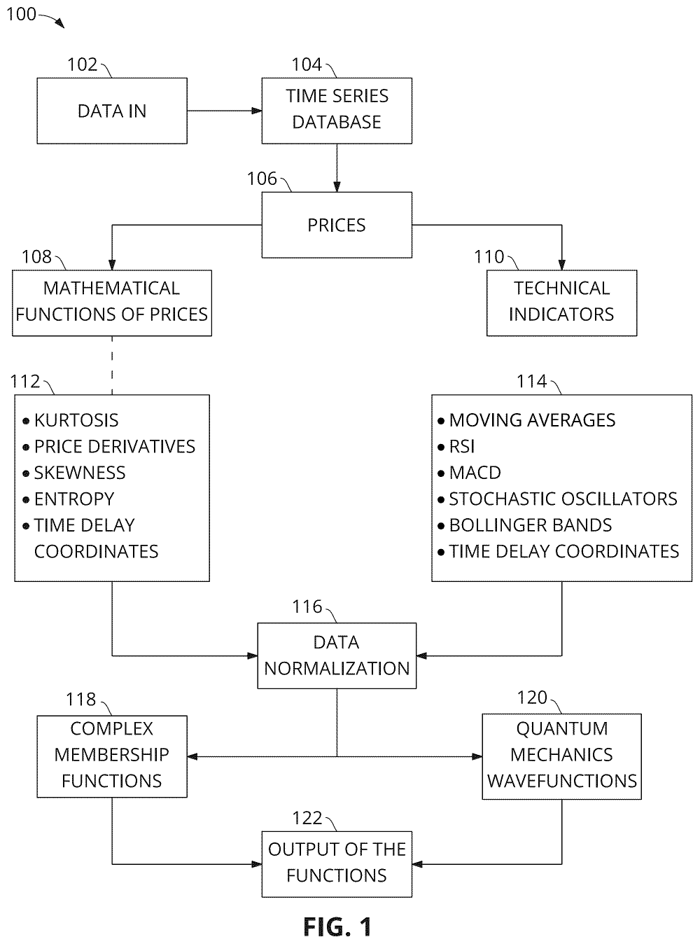

FIG. 1 illustrates a first portion of a schematic flow diagram of a Quantitative AI sub-system 100 of the present invention. Briefly, and described in more detail below, Quantitative AI sub-system 100 takes as input, quantitative data from one or more sources, and processes the quantitative data using one or more processing modules, systems, methods, engines, etc., to provide one or more outputs for further usage in the overall system of the present invention.

FIG. 1 shows a first portion of a method of processing 100 performed by the Quantitative AI System 100. This figure illustrates the flow of data through various components, each contributing to the analysis and prediction capabilities of the system, including DATA IN 102, TIME SERIES DATABASE 104, PRICES 106, MATHEMATICAL FUNCTIONS OF PRICES 108, TECHNICAL INDICATORS 110, KURTOSIS, PRICE DERIVATIVES, SKEWNESS, ENTROPY, TIME DELAY COORDINATES 112, MOVING AVERAGES, RSI, MACD, STOCHASTIC OSCILLATORS, BOLLINGER BANDS, TIME DELAY COORDINATES 114, DATA NORMALIZATION 116, COMPLEX MEMBERSHIP FUNCTIONS 118, QUANTUM MECHANICS WAVEFUNCTIONS 120, and OUTPUT OF THE FUNCTIONS 122.

The process begins with Data In 102, which represents the initial input of data into the system. In embodiments, initial input can include, but is not limited to, Events, companies, products, clinical trials, partnerships, competitors, medical statistics, future value assessment, a continuous stream of historical and real-time financial data related to over 500 publicly traded U.S. biotech companies, etc. In embodiments, a pre-processing phase is applied to Data In 102, prior to storage in time-series database 104. In embodiments, pre-processing can include a data cleaning phase to adjust raw time-series data to remove errors, noise, outliers, add missing values, augment data sets, correct inconsistencies, etc. In embodiments, the pre-processing phase can adjust data or otherwise manipulate the data to make the data suitable for forecasting, and/or predicting the best market timing for an asset in a biotechnology company's portfolio.

In embodiments, the pre-processing phase can include a plurality of sub-phases, such as Data Collection and Cleaning, Resampling and Alignment, and, optionally, Data Enrichment. The data collection and cleaning sub-phase includes cleaning the Data In 102 which can include filling in missing values by imputing, or interpolation, and/or removal of duplicate or redundant data. The resampling and alignment sub-phase can set sampling frequencies at consistent temporal periods, such as minute-by-minute, hourly, daily, etc., and can align collected data items using a timestamp associated with each collected data item. The data enrichment sub-phase can collect, or ingest, volume and/or liquidity data associated with one or more data items 102 and store the volume and/or liquidity data in associated with Data In 102.

This data is then stored in a Time Series Database 104, which is specifically designed to handle time-series data efficiently. The database serves as a repository for storing historical data, such as prices 106 and trading volumes of assets, such as stock(s) for one or more Biotechnology companies, which are important for subsequent analysis. Prices 106 are extracted from the Time Series Database 104 and serve as the primary data source for further processing.

Prices 106 are subjected to two parallel analytical paths: Mathematical Functions of Prices 108 and Technical Indicators 110. Mathematical Functions of Prices 108 involve the application of various mathematical techniques to the price data. These techniques include, Historical Series Price, n^{th} order return, n^{th} order finite differences (derivatives), Kurtosis, Price Derivatives, Skewness, Entropy, and/or Time Delay Coordinates 112. Each of these functions provides insights into different aspects of the price data, such as volatility, trends, and statistical properties, which are important for understanding market dynamics.

TABLE 1
Mathematical Techniques

| Mathematical functions | |
|---|---|
| description | Mathematical formula |
| Historical series price | p̅ = (p₁, . . . , p_{T}) |
| n^{th} order return | ${r}_{n} = \frac{{p}_{i} - {p}_{i - n}}{{p}_{i - n}}$ |
| Kurtosis of returns | $\tilde{{μ}_{4}} = E [ {( \frac{{r}_{n} - {μ}_{n}}{{σ}_{n}} )}^{4} ]$ |
| | μ_{π}, σₙ are average and standard deviation of rₙ |
| n^{th} order finite differences | dₙ = pᵢ − pᵢ₋ₙ |
| (derivatives) | |
| Skewness of retums | $\tilde{{μ}_{3}} = E [ {( \frac{{r}_{n} - {μ}_{n}}{{σ}_{n}} )}^{3} ]$ |
| | μᵤ, σₙ are average and standard deviation of rₙ |
| Time delay coordinates | $\overline{{p}_{td}} ( τ ) = ( {p}_{1} , {p}_{1 + τ} , {p}_{2 + τ} , … , {p}_{n} )$ |

As provided herein, Table 1 can be a non-limiting example of mathematical techniques utilized by Mathematical Functions of Prices 108.

Technical Indicators 110 apply a set of financial metrics to the price data, including Moving Averages 114, Relative Strength Index (RSI) 114, Moving Average Convergence Divergence (MACD) 114, Stochastic Oscillators 114, Bollinger Bands 114, and Time Delay Coordinates 114. These indicators are used to identify patterns and signals in the market, aiding in the prediction of future price movements. The outputs from both the Mathematical Functions of Prices 108 and Technical Indicators 110 are then subjected to Data Normalization 116.

TABLE 2
Technical Indicators

| Technical indicators | |
|---|---|
| description | Mathematical formula |
| Historical series price | p̅ = (p₁, . . . , p_{T}) |
| n^{th} order return | ${r}_{n} = \frac{{p}_{i} - {p}_{i - n}}{{p}_{i - n}}$ |
| n^{th} order moving averages | ${SMA}_{n} ( {p}_{t} ) = \frac{{p}_{t} + ⋯ {p}_{t - n}}{n}$ |
| Exponential moving averages | ${EMA}_{n} ( {p}_{t} ) = α {p}_{t} + ( 1 - α ) {p}_{t - 1}$ $α = \frac{1}{n + 1}$ |
| Relative strength Index (RSI) | ${RSI}_{n} = 100 + ( \frac{100}{1 + \frac{n days average gain}{n days average loss}} )$ |
| Moving Average Convergence | MACDᵢⱼ = EMA(i) − EMA(j) |
| Divergence (MACD) | i,j depend on the different model |
| Stochastic Oscillators (STO) | $STO = 100 * \frac{{p}_{t} - {low}_{n}}{{high}_{n} - {low}_{n}}$ |
| Bollinger Bands (BB) | BBandsₙ = SMAₙ (pₜ ) ∓ d * σᵢ |

As provided herein, Table 2 can be a non-limiting example of Technical Indicators utilized by Technical Indicators 110.

Data Normalization 116 ensures that the data is standardized and scaled appropriately, making the data suitable for further analysis. Normalization maintains consistency and comparability across different data sets. In embodiments, normalization can include, but is not limited to, scaling inputs, data items, prices, or variables, to a common range, or standardizing inputs, data items, prices, or variables, to make them comparable and suitable for analysis. In embodiments, Quantitative AI System 100 includes several different tools for normalization such as, Min-Max normalization, Z-score normalization, log normalization, or using scaling functions such as sigmoid normalization or a hyperbolic tangent normalization, as illustrated in Table 3, below.

TABLE 3
Normalization Functions

| Normalization function | Mathematical formulation |
|---|---|
| min-max normalization | $\begin{matrix}{X}_{norm} = a + \frac{X - {X}_{min}}{{X}_{max} - {X}_{min}} ( b - a ) \\ normalization between a , b\end{matrix}$ |
| log normalization | Xₙₒᵣₘ = log(X) |
| Z-score normalization | $\begin{matrix}{X}_{norm} = \frac{X - μ}{σ} \\ normalization between 0 , 1\end{matrix}$ |
| hyperbolic tangent | f(x) = tanh(x) |
| normalization | normalization between −1, 1 |
| sigmoid normalization | $\begin{matrix}f ( x ) = \frac{1}{1 + {e}^{- x}} \\ normalization between 0 , 1\end{matrix}$ |

Following normalization, data is processed through Complex Membership Functions 118 and Quantum Mechanics Wavefunctions 120. Complex member function module 118 is configured to extend traditional fuzzy set theory by mapping real inputs to points in the complex plane, rather than just to real values between 0 and 1. In quantum fuzzy sets, complex membership functions map uncertainty with quantum-like behavior. The amplitude represents conventional membership degree while the phase encodes quantum interference effects, allowing for representation of contradictory states simultaneously. This creates a richer semantic space where data points can exist in superposition states analogous to quantum mechanics. In embodiments, Complex Membership Functions 118 include a plurality of functions such as, but not limited to, Singleton membership function, Gaussian membership function, Hyperbolic tangent membership function, Sigmoid membership function, etc. The Singleton membership function acts as a precise selector, picking out exactly one specific value. Gaussian membership function creates smooth, gradual transitions around a central value. Hyperbolic tangent membership function creates balanced transitions between opposing states. Sigmoid membership function creates asymmetrical transitions, effectively modeling thresholds where values become increasingly significant after crossing a certain point.

TABLE 4
Real Membership Functions

| Complex membership functions | Mathematical formulation |
|---|---|
| Singleton membership function | μ(x, β, ϕ) = 1 if xcos ϕ = β [symbol] |
| | or |
| | μ(x, β, ϕ) = 1 if xsin ϕ = β_{Im} |
| | else |
| | μ(x, ϕ) = 0 |
| | β_{Re} = βcosϕ |
| | β_{Im} = β sinϕ |
| | x is the normalized function, β, ϕ are |
| | parameters of the model |
| Gaussian membership function | $μ ( x , m , σ , λ ) = ρ e \text{?}$ $ρ = {e}^{- \frac{1}{2} {( \frac{x - m}{σ} )}^{2}}$ $θ = - {{e}^{- \frac{1}{2} {( \frac{x - m}{σ} )}^{2}} ( \frac{x - m}{σ} )}^{2} λ$ |
| | x is the normalized function, m, σ, λ are |
| | parameters of the model |
| Hyperbolic tangent membership | μ(x, a, b) = tanh(ax)e [symbol] |
| function | x is the normalized function, a, b, are |
| | parameters of the model |
| Sigmoid tangent membership function | $μ ( x , a , b ) = \frac{1}{1 + {e}^{- ax}} e {\text{?}}^{[ cos ( bx ) + sin ( bx ) ]}$ |
| | x is the normalized function, a, b are |
| | parameters of the model |

[symbol]

indicates data missing or illegible when filed

As provided herein, Table 4 can be a non-limiting example of Real Membership functions utilized by Complex Membership Functions 118.

TABLE 5
Fuzzy Membership Functions

| Real fuzzy membership functions | Mathematical formulation |
|---|---|
| Triangular membership function | $μ ( y ) = 0 if y < a$ $or$ $μ ( y ) = \frac{y - a}{b - a} if a \leq y \leq b$ $or$ $μ ( x ) = \frac{c - y}{c - b} if b \leq y \leq c$ $or$ $μ ( y ) = 0 if y > c$ $y is the output of the Layer 1 , a , b , c are \\ parameters of the model$ |
| Trapezoidal membership function | $μ ( y ) = 0 if y < a$ $or$ $μ ( y ) = \frac{y - a}{b - a} if a \leq y \leq b$ $or$ $μ ( y ) = 1 if b < y < c$ $or$ $μ ( y ) = \frac{d - y}{d - c} if c \leq y \leq d$ $or$ $μ ( y ) = 0 if y > d$ $y is the output of the Layer 1 , a , b , c , d are \\ parameters of the model$ |
| Gaussian membership function | $μ ( y ) = {e}^{- \frac{1}{2} ( \frac{y - m}{σ} ) 2}$ |
| | y is the output of the Layer 1, m, σ |
| | are parameters of the model |
| Sigmoid membership function | $μ ( y ) = \frac{1}{1 + {e}^{- i ( y - b )}}$ |
| | y is the output of the Layer 1, c, b |
| | are parameters of the model |
| Bell membership function | $μ ( y ) = \frac{1}{1 + {( \frac{y - a}{b} )}^{2 c}}$ |
| | y is the output of the Layer 1, a, b, |
| | c are parameters of the model |

As provided herein, Table 5 can be a non-limiting example of Fuzzy Membership functions utilized by Complex Membership Functions 118.

Quantum mechanics wavefunction module 120 is configured to map a particle's possible states to complex numbers that contain both probability and phase information. In a complex membership function, the amplitude (or modulus) tells you the degree of membership, while the phase angle provides additional information about the nature of that membership. Similarly, in quantum mechanics, the squared amplitude of the wave function tells you the probability of finding a particle in a particular state, while the phase encodes how different states interfere with each other. When complex membership functions overlap in fuzzy logic, they can produce constructive or destructive interference based on their relative phases. Likewise, when quantum wave functions overlap, their phases determine whether they reinforce each other (constructive interference) or cancel out (destructive interference). Both systems use complex numbers to represent a richer information space than real numbers alone could provide. In fuzzy logic, this extra dimension might represent uncertainty or directionality. In quantum mechanics, this extra dimension enables quantum superposition and interference effects, and includes a plurality of functions such as, but not limited to, price wave function, Energy function, Quantum harmonic oscillator function, Quantum Superposition function, etc.

In embodiments, a Price wave function is like a complex membership function that maps market movements to both magnitude and direction. The amplitude represents price volatility while the phase indicates market sentiment or momentum. Like quantum states before measurement, future prices exist in a probability distribution rather than a single definite value. An Energy function works similarly to a membership function by mapping system states to energy levels. In quantum mechanics, these are discrete (quantized) rather than continuous. The complex nature of this function captures both the energy value and how it relates to the system's evolution over time, just as complex membership functions capture multiple dimensions of information. A Quantum harmonic oscillator function describes particles trapped in a potential well, like a ball in a bowl. Its complex wave function maps position to probability amplitudes, similar to how complex membership functions map inputs to degrees of membership. The oscillator states have both energy (amplitude information) and phase relationships, creating a spectrum of possible states with well-defined relationships. A Quantum Superposition function represents a system existing in multiple states simultaneously until measured. This resembles complex membership functions where an input can have partial membership in multiple fuzzy sets simultaneously. The superposition function combines multiple base states with complex coefficients, where the phase relationships determine how these states interfere with each other when measured, analogous to how the phase in complex membership functions determines how different membership aspects interact.

TABLE 6
Quantum Mechanics Functions

| QM function | Mathematical formulation |
|---|---|
| price wavefunctions | $ψ ( x , t ) = {ψ}_{0} {e}^{- \frac{n}{h} ε}$ |
| | x is the normalized function, ψ₀ is the |
| | probability distribution function of a series |
| | of returns, E is the energy of the series, i is |
| | the imaginary number |
| Energy | ${E}_{n} = ℏω ( n + \frac{1}{2} )$ |
| | ω is the angular frequency of the series, n |
| | is an integer that depends on the model |
| Quantum harmonic hoscillator | ${ψ}_{n} = \frac{1}{\sqrt{{2}^{n} n !}} {( \frac{m ω}{π ℏ} )}^{\frac{1}{4}} {e}^{- \frac{{mwx}^{2}}{2 h}} {H}_{n} ( \sqrt{\frac{m ω}{ℏ}} x )$ |
| | m, ω, ℏ are parameters of the model, x is |
| | the normalized function to the n^{th} oscillator |
| Quantum superposition of states | $ψ ( x ) = {\sum }_{i = 1}^{n} {c}_{n} {ψ}_{n}$ |
| | normalization between −1.1 |

As provided herein, Table 4 can be a non-limiting example of Quantum Mechanics functions utilized by Quantum mechanics wavefunction module 120.

Complex Membership Functions 118 utilize fuzzy logic to handle uncertainty and imprecision in the data, providing a more nuanced analysis.

Quantum Mechanics Wavefunctions 120 apply principles from quantum mechanics to model complex interactions within the data, offering a distinct perspective on market behavior. The processed data is subsequently output as Output of the Functions 122, representing the culmination of the analytical process. Outputs of the Functions 122 are provided as input to Method 300, as described further below.

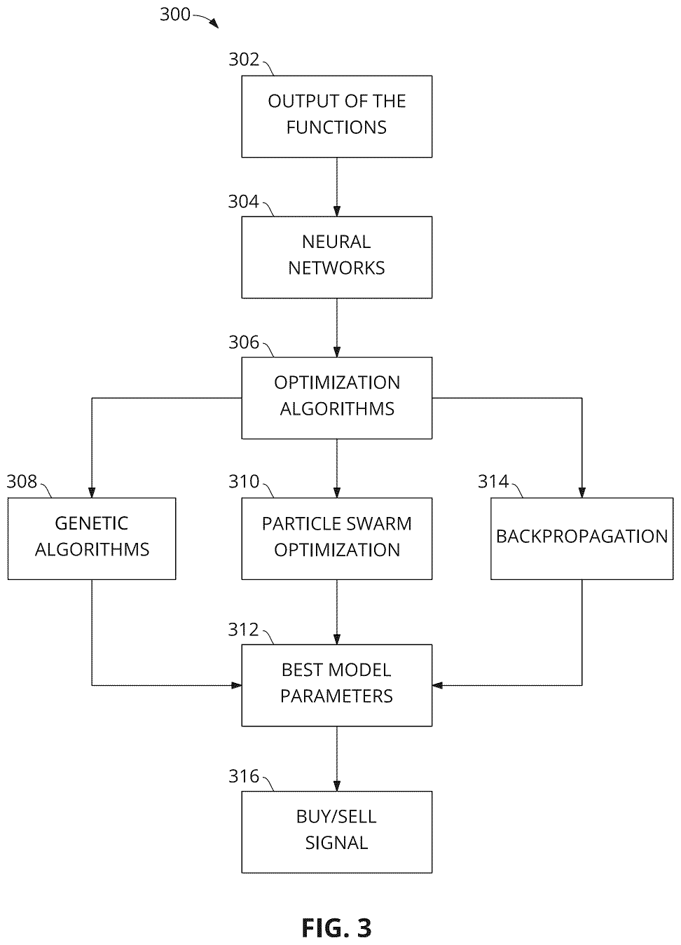

FIG. 3 shows a second portion of a method of processing 300 performed by the Quantitative AI Model 808, where the outputs of functions 122 are provided as input 302. FIG. 3 illustrates the flow of data through various components, each contributing to the generation of buy/sell signals 316 for stocks, shares, or equities. The process begins with the Output of the Functions 122, which serves as the initial input to method 300. This output is derived from complex membership functions and quantum mechanics wavefunctions, providing a rich set of features for further analysis.

Outputs 302 are then fed into Neural Networks 304, which are designed to learn complex patterns from the data. Neural networks 304 are capable of handling non-linear relationships and adapting to changing market conditions, making them suitable for financial time series analysis. Neural networks 304 are artificial neural networks, and include at least one feedforward neural network (FFNN), and at least one Adaptive Neuro Fuzzy Inference Neural Network (ANFNN), 200.

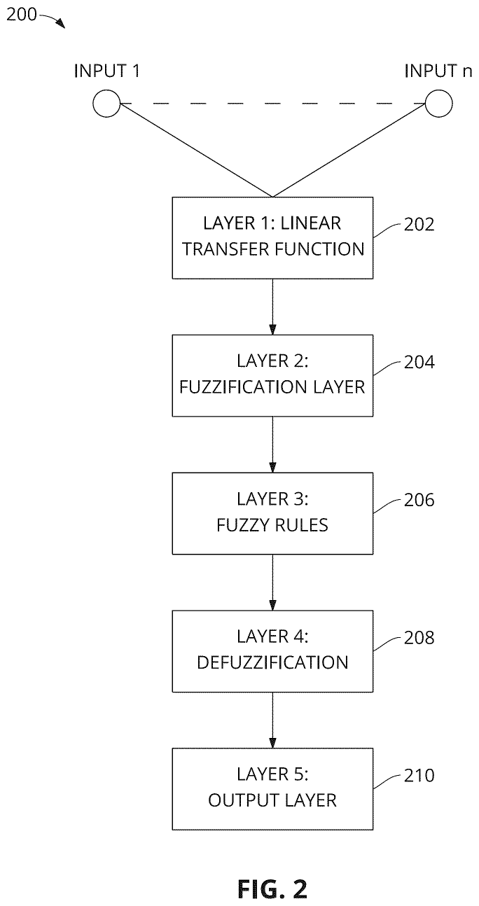

The at least one FFNN takes as input(s), outputs 302 from complex member function module 118 and Quantum mechanics wavefunction module 120. The at least one FFNN includes a plurality of layers organized in a sequential manner. In embodiments, the number of layers depends on the complexity of the FFNN, and generally ranges from 4 to 8 layers, but is not so limited. Each layer contains at least one of neuron(s), neurons in one layer are connected to one or more neurons in the subsequent layer through weighted connections. The number of neurons for each layer depends on the complexity and on the number of parameters of each FFNN. Each neuron of the at least one neuron applies an activation function to the weighted sum of input neurons, which introduces non-linearity into the FFNN. In embodiments, the activation function is one of a sigmoid activation function, a hyperbolic tangent (tanh) activation function, and/or rectified linear unit (ReLU) activation function. The at least one Adaptive Neuro Fuzzy Inference Neural Network (ANFNN) is described further with respect to FIG. 2, below.

Following processing by Neural Networks 304, the data is processed by Optimization Algorithms 306. Optimization Algorithms 306 fine-tune Neural Networks 304 to achieve optimal performance. The optimization process involves several techniques, including Genetic Algorithms 308, Particle Swarm Optimization 310, and Backpropagation 314. Each of these algorithms are configured to adjust the model parameters 312 of Neural Networks 304 to enhance prediction accuracy.

Genetic Algorithms 308 draw inspiration from the process of natural selection and are employed to evolve and enhance trading strategies. These algorithms assist in identifying the most relevant input features and parameters for predictive models. For example, Genetic algorithms 308 mimic biological evolution, using selection, crossover, and mutation to evolve better solutions over generations. In embodiments, Genetic Algorithms 308 are optimizers, which given an input, such as profitability of a trading strategy, seek to minimize the time to accomplish the given input.

Particle Swarm Optimization 310 is an optimization algorithm with the same purpose of Genetic Algorithm 308. Particle swarm optimization 310 (PSO) is inspired by social behavior, where particles (solutions) move through the search space, influenced by their own and neighbors' past successes. While, Genetic algorithms 308 explore widely but can be slower to converge, while PSO 310 tends to converge faster but risks getting stuck in local optima. Qualitatively, Genetic Algorithms 208 rely on population diversity and competition, whereas PSO 310 relies on cooperation and collective intelligence. This method proves particularly beneficial for exploring the search space and locating global optima. PSO 310 is also used to optimize trading strategies achieving the best feature.

Backpropagation 314 is a widely utilized method for training neural networks 304, enabling the model to learn by minimizing the error between predicted and actual outcomes. The result of the optimization process is the determination of Model Parameters 312. These parameters represent an optimal configuration of the neural networks 304, ensuring that the model is well-suited for making accurate predictions. Once the parameters are identified, they are applied to generate a Buy/Sell Signal 316. This signal is the actionable output of the system, providing investors with guidance on market entry or exit based on the integrated analysis of quantitative data.

FIG. 2 shows an Adaptive Neuro Fuzzy Inference Neural Network 200, which is a component of the neural networks 304. ANFNN is designed to integrate the principles of neural networks and fuzzy logic to enhance decision-making processes in complex systems. The network is structured into five distinct layers, each contributing to the overall functionality and adaptability of the system, including LAYER 1: LINEAR TRANSFER FUNCTION 202, LAYER 2: FUZZIFICATION LAYER 204, LAYER 3: FUZZY RULES 206, LAYER 4: DEFUZZIFICATION 208, and LAYER 5: OUTPUT LAYER 210.

ANFNN 200 takes as inputs, outputs from functions 122, 302. The inputs can be various data points relevant to the system's operation, such as financial metrics or scientific data, depending on the specific application of the network. AFINN 200 is a hybrid model that combines the intuitive reasoning of fuzzy logic with the adaptive learning ability of neural networks. It is composed of five layers, each playing a specific role in processing and transforming input data into a final output.

Layer 1, the Linear Transfer Function 202, serves as the initial processing stage. This layer applies a linear transformation to the input data, preparing the data for further processing. The linear transfer function scales and normalizes the input data, ensuring that the data is in a suitable format for the subsequent layers 204, 206, 208, and 210.

Layer 2, the Fuzzification Layer 204, converts the crisp input values into fuzzy values. This transformation is necessary for managing uncertainty and imprecision in the data. By mapping input values to fuzzy sets, this layer enables the system to process data in a manner that mimics human reasoning, accommodating the nuances and complexities present in real-world data. In an exemplary embodiment, Fuzzification Layer 204 can transform exact values, such as “price=100” to one or more terms of degree, i.e. “price=High”, “price=Medium”, “price=low”.

Layer 3, the Fuzzy Rules 206, is where the main part of the fuzzy logic processing occurs. This layer applies a set of predefined fuzzy rules to the fuzzified inputs. These rules are designed to capture the relationships and interactions between different input variables, enabling the system to make inferences based on the fuzzy data. The fuzzy rules layer derives meaningful insights from the input data, leveraging the flexibility of fuzzy logic to handle complex decision-making scenarios. In embodiments, the set of pre-defined fuzzy rules can be structured using one or more logical operators, such as If-Then-Else, etc. In an exemplary embodiment, a predefined rule can take the form of “If price is high and volume is low, then expect a downward trend”. In embodiments, the predefined set of rules based on the fuzzy inputs are evaluated and their influence calculated for use in decision making, essentially mimicking the decision-making process of an expert using natural language reasoning.

Layer 4, the Defuzzification 208, converts the fuzzy outputs from the fuzzy rules layer 206 back into crisp values. Defuzzification produces actionable outputs that can be interpreted and utilized in practical applications. The defuzzification layer 208 ensures that the system's outputs are precise and relevant, translating the fuzzy logic inferences into concrete decisions or predictions.

Layer 5, the Output Layer 210, delivers the concluding results of the network's processing. This layer provides the system's outputs, which can be used for various purposes, such as generating buy/sell signals in financial markets or making predictions about market trends. The output layer represents the culmination of the network's processing, offering a clear and actionable outcome based on the integrated analysis of the input data.

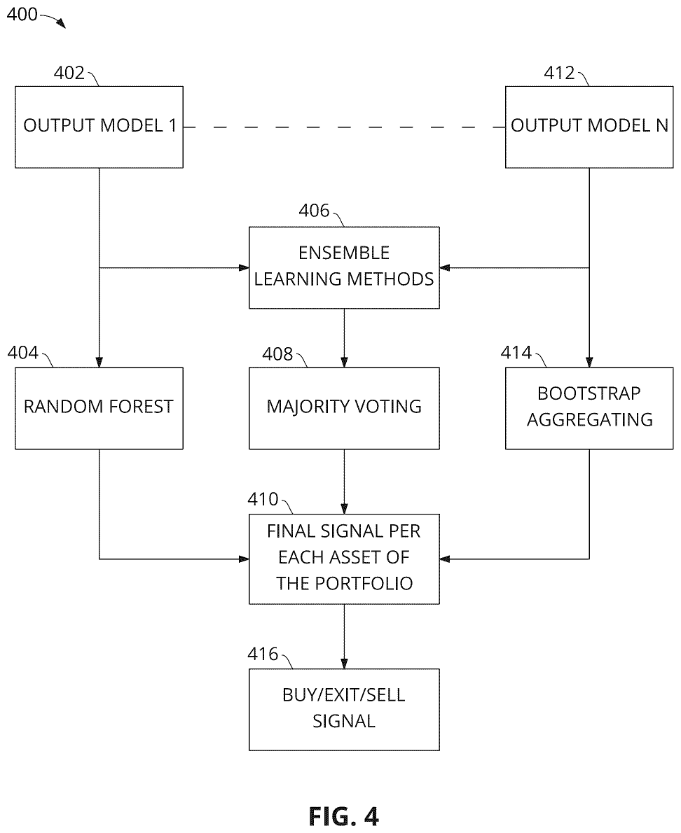

FIG. 4 shows an ensemble learning method 400 designed to refine and optimize investment signals for assets within a portfolio. Briefly, and explained in more detail Method 400 is employed to refine one or more Buy/Sell signals 316 provided from Nueral Networks 304, as described with reference to FIG. 3.

Method 400 begins with multiple output models, specifically Output Model 1 402 and Output Model N 412, which generate initial signals based on various predictive algorithms. These models provide diverse perspectives on market conditions, contributing to a robust analysis framework. In embodiments, the Output Models 402 . . . 412 can come from one or both of Qualitative AI 804 and/or Quantitative AI 808, as described above with reference to FIG. 8.

The ensemble learning methods 406 integrate outputs from the multiple models, specifically OUTPUT MODEL 1 402 and OUTPUT MODEL N 412. This integration is achieved through several techniques, including Random Forest 404, Majority Voting 408, and Bootstrap Aggregating 414. Each technique provides distinct advantages in refining the predictive accuracy of the system, ultimately leading to the FINAL SIGNAL PER EACH ASSET OF THE PORTFOLIO 410 and the BUY/EXIT/SELL SIGNAL 416.

Random Forest 404 constructs multiple decision trees during training, and the final prediction is derived from the mode of the classes or the mean prediction of the individual trees. In embodiments, Random Forest assigns confidence scores from 0 to 1 to each signal related to each stock in the portfolio evaluating the correlation between current and previous signals. This method is particularly effective in reducing overfitting and improving accuracy by averaging the results of many trees, ultimately leading to a final signal per each asset of the portfolio 410 and a buy/exit/sell signal 416.

Bootstrap Aggregating 414, also known as bagging, trains multiple models on different subsets of the training data, typically generated by random sampling with replacement. In embodiments, Bootstrap Aggregating 414 (Bagging) creates multiple subsamples of existing signals for each stock by randomly sampling with replacement from the full set of signals already generated. The predictions from these models are then averaged or voted upon to produce the final output, helping to reduce variance and improve stability.

Majority Voting 408 involves each model in the ensemble casting a “vote” for a particular class label, with the class receiving the majority of votes being selected as the final prediction. In embodiments, Majority Voting 408 takes the weighted inputs from both the Random Forest evaluation and Bagging to produce a single periodic signal for each stock. This approach ensures that the most supported outcome is chosen, enhancing the reliability of the signal 416.

The integration of these ensemble learning methods 406 results in a final signal per each asset of the portfolio 410. This signal represents a comprehensive analysis, considering the diverse insights from the various models and ensemble techniques. The final signal is translated into a Buy/Exit/Sell signal 416, providing actionable investment decisions for stakeholders. This signal is based on the combined insights from the ensemble learning methods 406, ensuring that the recommendations are well-informed and adaptive to changing market conditions.

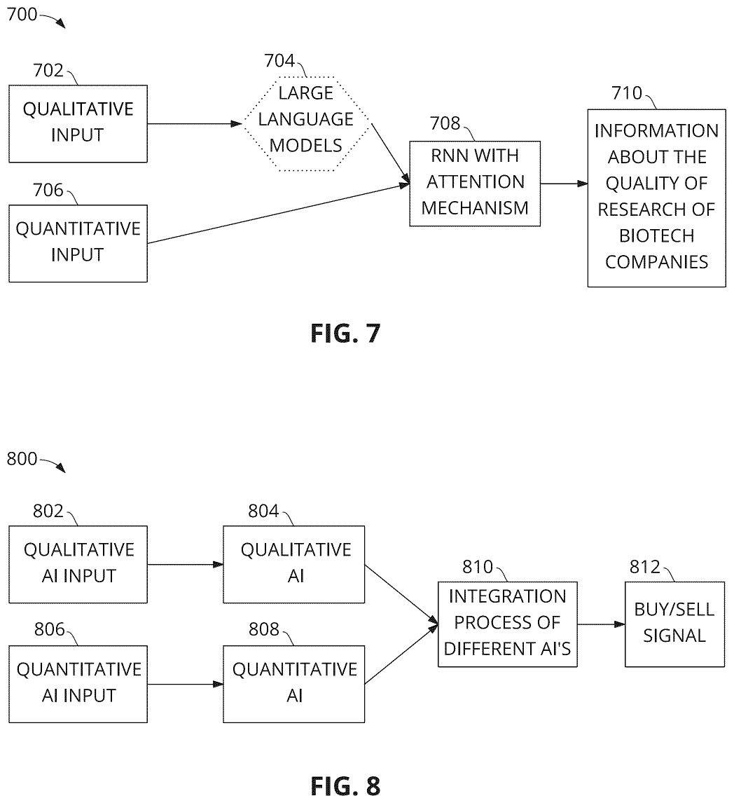

FIG. 7 shows an exploded diagram 700 of the Qualitative AI 804 which is utilized to assess the quality of research conducted by biotechnology companies. Qualitative AI 700 integrates both qualitative input 702 and quantitative input 706 data inputs to generate comprehensive insights. The process begins with a Qualitative Input 702, which consists of non-numerical data such as textual information from research papers, news articles, and other publicly available sources. This input is utilized to understand the context and nuances of the biotechnology market, including the reputation of research teams, innovation indices, and competitive landscapes. Additionally, a Quantitative Input 706 may be utilized to complement the qualitative data, providing numerical insights that enhance the analysis. The integration of these inputs is facilitated by Large Language Models 704, which process the qualitative data effectively, while the RNN with Attention Mechanism 708 ensures that the most relevant information is prioritized in the analysis. Finally, the output generated will include critical information about the quality of research of biotech companies 710, aiding in informed decision-making.

The Qualitative Input 702 is processed by Large Language Models 704. These models are designed to extract meaningful insights and features from the qualitative data. They employ advanced natural language processing techniques to analyze the qualitative aspects of the data, providing a deeper understanding of the scientific and market context. Simultaneously, a Quantitative Input 706 is provided, which includes numerical data such as stock prices, trading volumes, and other financial metrics. This input is utilized to identify patterns and trends in the market, offering a quantitative perspective on the biotechnology sector, alongside the QUALITATIVE INPUT 702 and the LARGE LANGUAGE MODELS 704.

Both the outputs from the Large Language Models 704 and the Quantitative Input 706 are fed into an RNN with Attention Mechanism 708. This component is responsible for integrating the qualitative and quantitative insights, focusing on the most relevant data points. The attention mechanism within the RNN 708 allows the system to prioritize certain inputs over others, ensuring that the most important information is highlighted in the analysis. At its core, the Attention Mechanism 708 allows each of the models to dynamically focus on different parts of the input when producing each element of the output. Rather than compressing all information into a fixed-size representation, the Attention Mechanism 708 helps the model decide what's relevant for each step of processing. The Attention process, of Attention Mechanism 708, involves calculating relevance scores between a query and a set of keys. These relevance scores are converted to weights using a softmax function, creating a probability distribution. These weights are then used to create a weighted sum of values associated with the keys, producing a context vector that emphasizes the most relevant information. The final output of this process is Information About the Quality of Research of Biotech Companies 710. In embodiments, Information 710 includes, but is not limited to, such as quality sores related to clinical trials, research papers, and biotech innovations to assess growth potential. This output provides a comprehensive assessment of the research quality, taking into account both the qualitative insights from the Large Language Models 704 and the quantitative data from the Quantitative Input 706. This information is crucial for investors and analysts to make informed decisions regarding biotechnology investments, as the output offers a detailed evaluation of the scientific and market potential of biotech companies.

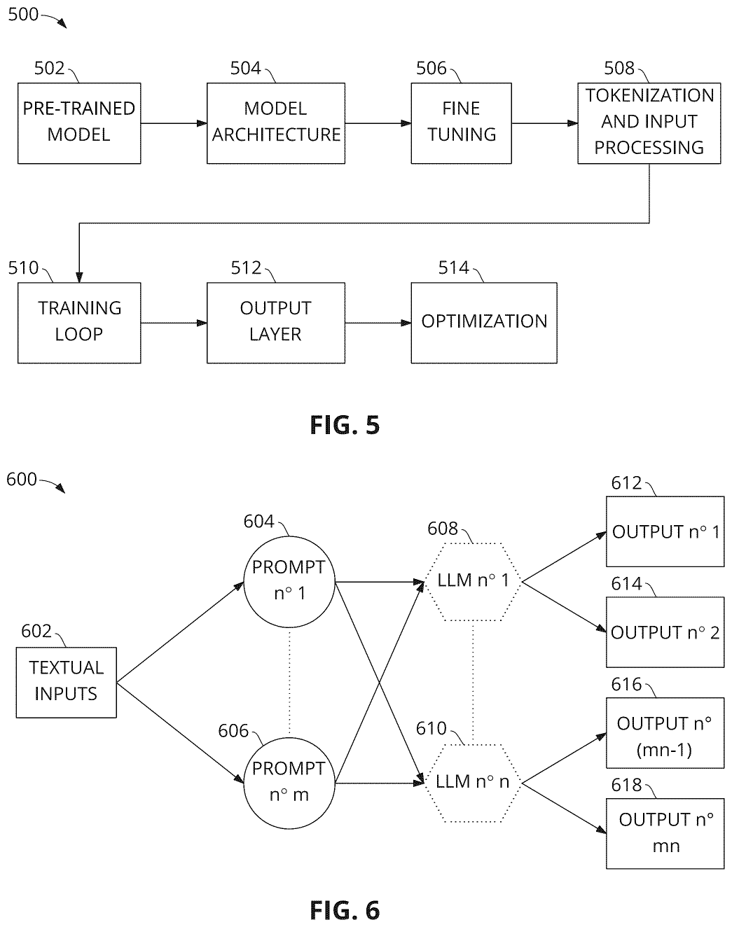

FIG. 5 shows a method 500 for constructing Large Language Models (LLMs) 704, which plays a significant role in the Qualitative AI 804 of the described technology. This method outlines a systematic approach to developing and refining LLMs 704 to enhance their performance in domain-specific applications.

The process begins with a pre-trained model 502, which serves as the foundational element of the LLM. This pre-trained model is typically developed using a large, general dataset, allowing the model to capture a wide range of linguistic patterns and structures. The use of a pre-trained model significantly reduces the time and computational resources required to develop a new model from scratch, as the pre-trained model provides a robust starting point for further customization.

Following the pre-trained model 502, the method involves a model architecture 504, where the pre-trained model 502 is integrated into a customized architecture tailored to the specific needs of the application. This step involves selecting the appropriate layers, connections, and configurations that will enable the model to effectively process and analyze the target data. The design of the model architecture 504 ensures that the LLM can handle the complexities and nuances of the specific domain in which the model is intended to operate.

Fine tuning 506 is the next step in the process, where the model is exposed to a smaller, domain-specific dataset. During this phase, the model's parameters, such as weights and biases, are adjusted to better align with the specific characteristics and requirements of the target domain. This phase enhances the model's ability to generate accurate and relevant outputs by refining the model's understanding of the domain-specific data.

Tokenization and input processing 508 are necessary for preparing the data for the LLM. This step involves breaking down the input data into manageable units, or tokens, that the model can process. Tokenization ensures that the data is in a format that the model can understand and work with, while input processing involves any additional steps needed to clean, normalize, or otherwise prepare the data for analysis.

The training loop 510 is where the model processes batches of data in a repetitive manner, calculates the loss between the model's predictions and the actual data, and updates the model's parameters accordingly. This repetitive process enables the model to learn from mistakes and gradually enhance performance over time. The training loop ensures that the model can adapt effectively to new, unseen data.

The output layer 512 is where the final predictions of the model are generated. This layer is fine-tuned 506 to ensure that the model's outputs are accurate and relevant to the specific task at hand. The design and configuration of the output layer 512 translates the model's internal representations into meaningful predictions. Optimization 514 is performed to enhance the model's performance further. This step involves using various optimization techniques to fine-tune the model's parameters, ensuring that the model operates efficiently and effectively. Optimization maximizes the model's accuracy and minimizing any errors or biases in its predictions.

FIG. 6 illustrates the structure 600 of Large Language Models (LLMs) 704, which plays a significant role in the Qualitative AI subsystem. The structure starts with textual inputs 602, comprising numerical and non-numerical data related to publicly available information about research, company profiles, and competitive landscapes.

The textual inputs 602 are processed into prompts, specifically prompt n°1 604 and prompt n° m 606. These prompts are designed to guide the LLMs 608-610 in extracting meaningful insights from the textual data. Each prompt is tailored to elicit specific information from the LLMs, ensuring that the most relevant data is highlighted in the analysis. The prompts are fed into a series of LLMs, including LLM n° 1 608 and LLM n° n 610. The LLMs are sophisticated models capable of processing large volumes of textual data to extract meaningful insights. They employ advanced natural language processing techniques to analyze the qualitative aspects of the data, providing a deeper understanding of the scientific and market context. Each LLM is fine-tuned to focus on particular aspects of the data, ensuring comprehensive coverage of the information. In embodiments, a custom algorithm processes the heterogeneous outputs from multiple Large Language Models (LLMs), wherein each LLM produces distinct textual outputs 612,614 for even the same prompt 604. The algorithm extracts the main sentence keywords through stemming operations, reducing words to their root forms to eliminate morphological variations. These stemmed keywords are subsequently transformed into numerical vector representations via embedding techniques, thereby texts into numbers. The resulting high-dimensional numerical embeddings serve as structured inputs for the Qualitative AI System 804, enabling computational processing of semantically rich information derived from diverse LLM interpretations.

The outputs generated by the LLMs are represented as output n°1 612, output n°2 614, output n° (mn−1) 616, and output n°mn 618. These outputs contain the extracted insights and features relevant to the biotechnology market. The outputs play inform the subsequent stages of the Qualitative AI 804, as they provide a detailed evaluation of the scientific and market potential of biotech companies. The outputs are used to assess the quality of research conducted by biotechnology companies, aiding in informed decision-making.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus”, or “System” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

It should be understood, of course, that the foregoing relates to exemplary embodiments of the invention and that modifications may be made without departing from the spirit and scope of the invention as set forth in the following claims.

What is claimed is:

1. An Artificial Intelligence (AI) system for predicting market impact of regulatory approvals for a company, comprising:
at least one processor, and at least one memory;
a Qualitative AI module, executed by the processor, configured to ingest one or more qualitative inputs, and to process the one or more qualitative inputs using one or more large language models, and an attention mechanism to generate one or more qualitative insights regarding the company;
a Quantitative AI module, executed by the processor, configured to ingest one or more quantitative inputs, and to analyze using a plurality of neural networks the one or more inputs to generate one or more quantitative insights regarding the company;
an integration module, executed by the processor, operatively coupled to the Qualitative AI module and the Quantitative AI module, the integration module being configured to aggregate, weigh, and synthesize the one or more qualitative insights and the one or more quantitative analyses into a comprehensive market prediction signal; and
a decision module, executed by the processor, configured to output actionable investment signals based on the comprehensive market prediction signal for guiding buy, sell, or exit decisions.

2. The system of claim 1, wherein the plurality of neural networks further comprise:
at least one Adaptive Neuro Fuzzy Inference Neural Network having:
a first layer configured to transform the one or more quantitative inputs into one or more transformed inputs;
a second layer configured to perform fuzzification of the one or more transform inputs to form one or more fuzzy inputs;
a third layer configured to apply one or more fuzzy rules to the one or more fuzzy inputs to determine one or more inferences or relationships to form one or more fuzzy outputs;
a fourth layer configured to defuzzify the one or more fuzzy outputs based on one or more rules to form one or more defuzzified outputs; and
a fifth layer configured to generate one or more signals based on the one or more defuzzified outputs.

3. The system of claim 1, wherein the attention mechanism further comprises:
a recurrent neural network configured to prioritize one or more qualitative inputs over one or more additional qualitative inputs.

4. The system of claim 1, wherein the one or more qualitative inputs one or more non-numerical inputs selected from: textual information derived from research papers, news articles, and publicly available sources.

5. The system of claim 1, wherein the one or more qualitative insights are one of research quality of the company, innovation indices of the company, a company profile, or competitive positioning of the company.

6. The system of claim 1, wherein the one or more quantitative inputs is one or more numerical time-series data, one or more stock prices, one or more trading volumes, or one or more financial metrics.
